(19) United States
(12) Patent Application Publication
(10) Pub. No.: US 2026/0169574 A1
(43) Pub. Date: Jun. 18, 2026

(54) KEYBOARD DEVICE AND KEYBOARD INPUT METHOD

(71) Applicant: Chicony Electronics Co., Ltd., New Taipei City (TW)

(72) Inventors: Shih Hao Lu, New Taipei City (TW); Hung-Hsuan Lin, New Taipei City (TW)

(73) Assignee: Chicony Electronics Co., Ltd., New Taipei City (TW)

(21) Appl. No.: 19/086,153

(22) Filed: Mar. 21, 2025

(30) Foreign Application Priority Data
Dec. 16, 2024 (TW) 113148913

(51) Int. Cl. G06F 3/023

(52) U.S. Cl. CPC G06F 3/0233

(57) ABSTRACT

Provided are a keyboard device and a keyboard input method. The keyboard device includes a key module and a controller. The controller is electrically connected to the key module. The controller is configured to obtain multiple pressing distances of multiple keys of the key module. The controller determines whether multiple specific keys in the key module are lightly touched based on the multiple pressing distances. When the controller determines that the multiple specific keys are lightly touched, the controller outputs a control command. The multiple pressing distances of the multiple specific keys that are lightly touched are less than a first distance threshold.

### CROSS-REFERENCE TO RELATED APPLICATION

This application claims the priority benefit of Taiwan application serial no. 113148913, filed on Dec. 16, 2024. The entirety of the above-mentioned patent application is hereby incorporated by reference herein and made a part of this specification.

### BACKGROUND

### Technical Field

The disclosure relates to an input device, and in particular to a keyboard device and a keyboard input method.

### Description of Related Art

A single key of a traditional keyboard device can only provide a general pressing determination, and output the determination result of being pressed or not being pressed. Moreover, the traditional keyboard device can only provide relatively simple functions of shortcut keys or key combinations. More complex gesture operations of the user cannot be detected, and functions of diverse shortcut keys and key combinations cannot be implemented either.

### SUMMARY

The disclosure provides a keyboard device and a keyboard input method, which can implement a convenient light touching input function.

The keyboard device of the disclosure includes a key module and a controller. The controller is electrically connected to the key module. The controller is configured to obtain multiple pressing distances of multiple keys of the key module. The controller determines whether multiple specific keys in the key module are lightly touched based on the pressing distances. When the controller determines that the specific keys are lightly touched, the controller outputs a control command. The pressing distances of the specific keys that are lightly touched are less than a first distance threshold.

The keyboard input method of the disclosure is adapted for a keyboard device. The keyboard input method includes the following steps: multiple pressing distances of multiple keys of a key module of the keyboard device is obtained; whether multiple specific keys in the key module are lightly touched is determined based on the multiple pressing distances; and a control command is output when the specific keys are lightly touched. The pressing distances of the specific keys that are lightly touched are less than a first distance threshold.

Based on the above, the keyboard device and the keyboard input method can output the corresponding specific control command when the multiple specific keys are lightly touched.

In order to make the features and advantages of the disclosure more comprehensible, the following examples are given and described in detail with the accompanying drawings as follows.

### BRIEF DESCRIPTION OF THE DRAWINGS

FIG. 1 is a schematic diagram of a keyboard device according to an embodiment of the disclosure.

FIG. 2 is a flow chart of a keyboard input method according to an embodiment of the disclosure.

FIG. 3 is a flow chart of detecting a key pressing state according to an embodiment of the disclosure.

FIG. 4A is a schematic diagram of a key not being pressed according to an embodiment of the disclosure.

FIG. 4B is a schematic diagram of a key being lightly touched according to an embodiment of the disclosure.

FIG. 4C is a schematic diagram of a key being normally pressed according to an embodiment of the disclosure.

FIG. 5 is a schematic diagram of a keyboard according to an embodiment of the disclosure.

### DESCRIPTION OF THE EMBODIMENTS

In order to make the content of the disclosure more comprehensible, embodiments in which the disclosure may be implemented are listed as follows. In addition, wherever possible, elements/components/steps with the same reference numerals in the drawings and embodiments represent the same or similar components.

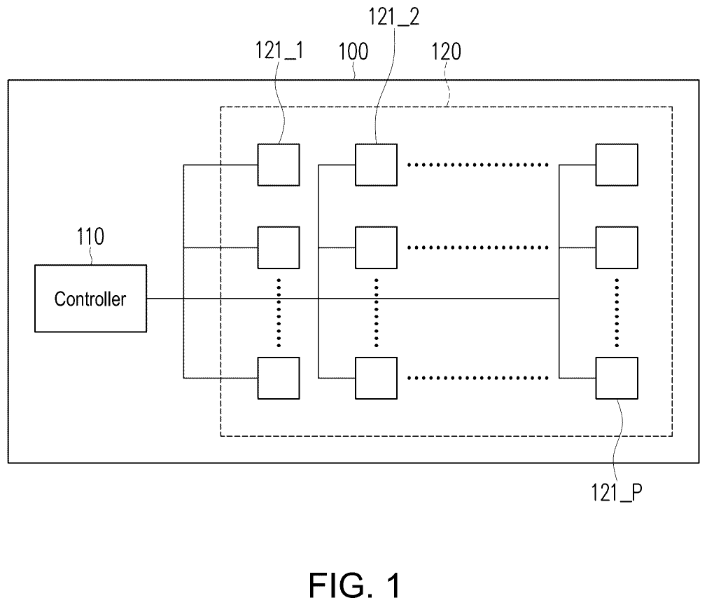

FIG. 1 is a schematic diagram of a keyboard device according to an embodiment of the disclosure. Referring to FIG. 1, a keyboard device 100 includes a controller 110 and a key module 120. The controller 110 is electrically connected to the key module 120. The key module 120 includes multiple keys 121_1 to 121_P, and P is a positive integer. The controller 110 is electrically connected to the keys 121_1 to 121_P. In the embodiment, the controller 110 may detect pressing strokes of the keys 121_1 to 121_P in real time to obtain multiple pressing distances of the keys 121_1 to 121_P in real time, and may respectively determine pressing results of the keys 121_1 to 121_P in real time based on the multiple pressing distances. In the embodiment, the keyboard device 100 may further be coupled to a computer device in a wired or wireless manner to output signals of the pressing results of the user pressing the keys 121_1 to 121_P to the computer device. In the embodiment, the controller 110 may include, for example, a data processing circuit and a memory. In an embodiment, the controller 110 may be, for example, a microcontroller (MCU), an application specific integrated circuit (ASIC), or a programmable logic device (PLD).

In the embodiment, the keys 121_1 to 121_P may be multiple analog keys, and may respectively provide corresponding signals of the pressing distances to the controller 110 based on the depths pressed by the user's finger to allow the controller 110 to, for example, output different control commands to the computer device based on the different pressing distances. In the embodiment, the keys 121_1 to 121_P may be multiple analog keys, and may have analog key shafts to sense different pressing depths. In an embodiment, the analog key shaft may be, for example, an optical shaft, a magnetic shaft, an inductive shaft, etc., but the disclosure is not limited thereto.

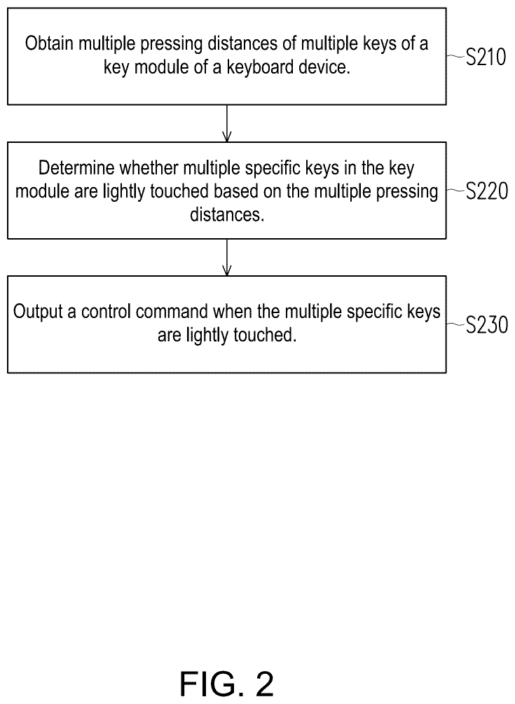

FIG. 2 is a flow chart of a keyboard input method according to an embodiment of the disclosure. Referring to FIG. 1 and FIG. 2, the keyboard device 100 may execute the following steps S210 to S230. In step S210, the controller 110 obtains multiple pressing distances of the multiple keys 121_1 to 121_P of the key module 120 of the keyboard device 100. In step S220, the controller 110 determines whether multiple specific keys of the key module 120 are lightly touched based on the multiple pressing distances. In step S230, when the multiple specific keys are lightly touched, the controller 110 outputs a control command.

In the embodiment, the controller 110 may determine whether a corresponding key is lightly touched or normally pressed based on the pressing distance. In this regard, the controller 110 may be preset with a first distance threshold, and when the pressing distance of a key is less than the first distance threshold, the controller 110 may determine that the corresponding key is lightly touched. In an embodiment, the controller 110 may also be preset with the first distance threshold and a second distance threshold. When the pressing distance of a key is less than the first distance threshold and greater than the second distance threshold, the controller 110 may determine that the corresponding key is lightly touched. The second distance threshold is less than the first distance threshold.

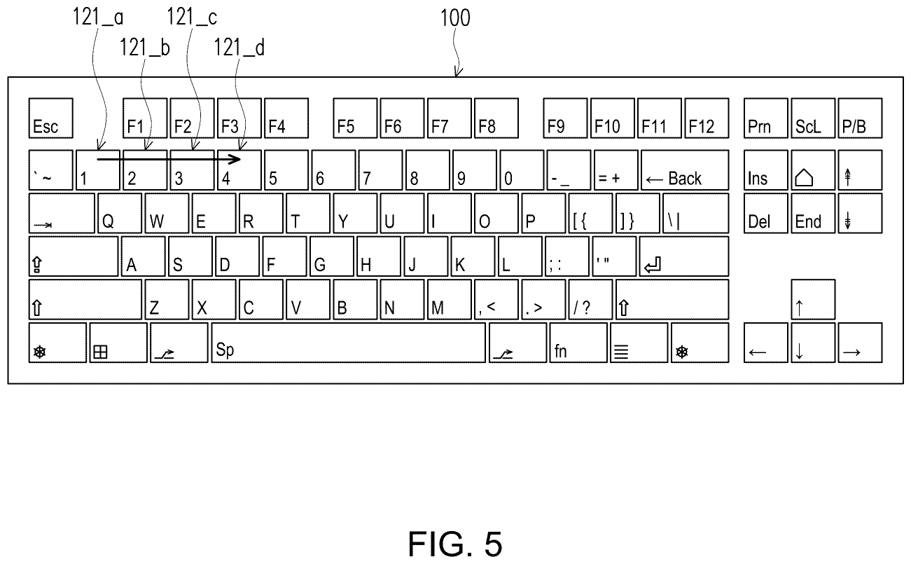

In the embodiment, the multiple specific keys may be a preset key combination, multiple keys that are prerecorded, or multiple keys that are compatible with a predetermined condition or logic. For example, referring to FIG. 5 first, the user may preset a key “Q”, a key “W”, a key “E” and a key “R” as a key combination, or for example, preset a key “D”, a key “F”, a key “G” and a key “H” as a key combination. In this regard, when the controller 110 determines that the multiple specific keys corresponding to the key combination are continuously and sequentially lightly touched in accordance with a preset pressing sequence within a preset time length (that is, the user sequentially lightly touches the multiple keys of “QWER” or “DFGH”)”, the controller 110 may output a corresponding specific control command. For another example, the controller 110 may record multiple specific keys on a path or a trajectory formed by the user's finger previously lightly touching and moving on the key module 120, for example, the user lightly touches the key “Q”, a key “A”, a key “Z”, a key “S” and a key “E”. That is, the controller 1108 may record the path or the trajectory formed by multiple specific keys (for example, a V-shaped path or trajectory formed by the key “Q”, the key “A”, the key “Z”, the key “S” and the key “E”) that are lightly touched. In some embodiments, the aforementioned path or trajectory may also be pre-recorded in a data processing circuit or a memory. In this regard, when the controller 110 determines that the multiple specific keys corresponding to the path or the trajectory are continuously and sequentially lightly touched in accordance with a preset pressing sequence within a preset time length (for example, the user lightly touches the multiple keys of “QAZSE” or “WSXDR” along the same V-shaped path or trajectory), the controller 110 may output a corresponding specific control command.

In the embodiment, the controller 110 may further store macros or comparison tables corresponding to different control commands of different specific key sets. The control command may be, for example, a mouse command, a shortcut key command, a gesture input command or an input method command. The input method command may be, for example, adapted to the Swype input method or the sliding gesture to password input method. In an embodiment, the control command may further be, for example, a simulated joystick command or a simulated mouse command.

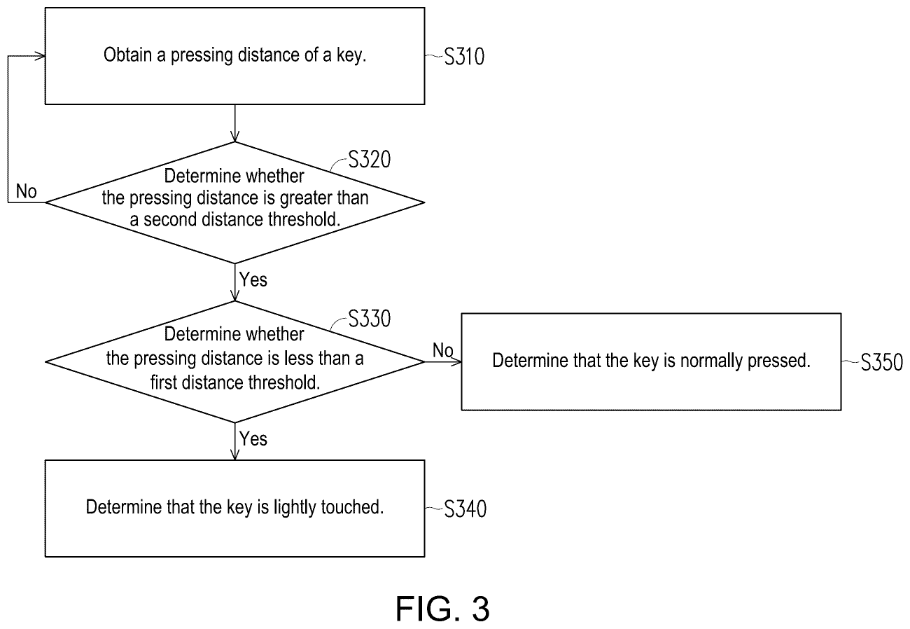

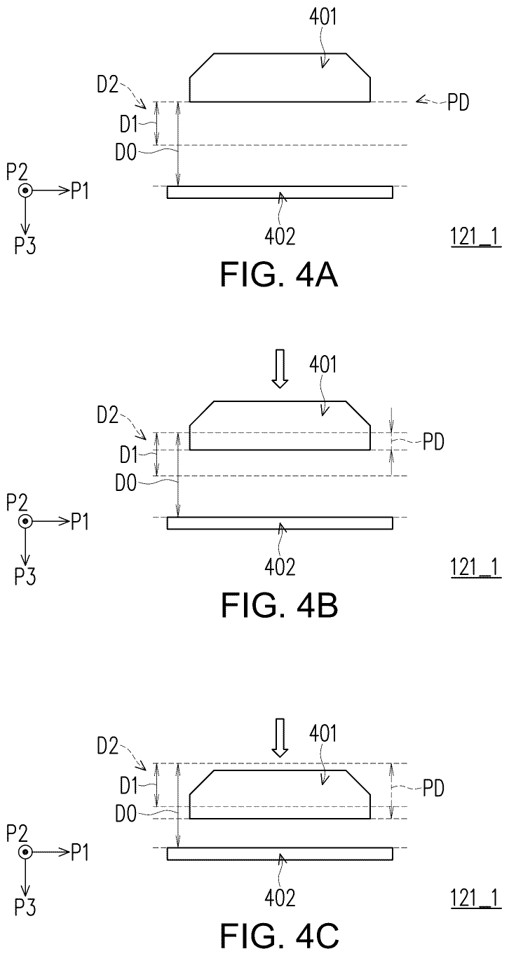

FIG. 3 is a flow chart of detecting a key pressing state according to an embodiment of the disclosure. Referring to FIG. 1, FIG. 3, and FIG. 4A to FIG. 4C, the following description takes the key 121_1 as an example, and the implementation manner and key structure of the keys 121_2 to 121_P may be applied by analogy. Referring to FIG. 4A first, FIG. 4A is a schematic diagram of a key not being pressed according to an embodiment of the disclosure. Taking a side view of the key 121_1 as an example, the key 121_1 may include a key cap 401 and a key base 402. Other key components (not shown) such as a shaft body, a return member (such as a spring) or a stabilizer may be further included between the key cap 401 and the key base 402, but the disclosure is not limited thereto. A bottom of the key cap 401 and an upper surface of the key base 402 may be respectively parallel to a plane formed by an extension of a direction P1 and a direction P2. When the key cap 401 is pressed, the key cap 401 may move toward a direction P3. The directions P1, P2, and P3 are perpendicular to each other. In an embodiment, the key 121_1 may further include a thin film switch. The thin film switch may be combined with an analog key shaft. When the thin film switch is triggered by the user pressing the key cap 401, the controller 110 may precisely determine that the key 121_1 is being normally pressed.

In the embodiment, when the key cap 401 is not pressed, there is a distance D0 between the bottom of the key cap 401 and the upper surface of the key base 402. The distance D0 may be a full pressing distance of the key 121_1. As shown in FIG. 4A, in a condition where the key is not pressed, the controller 110 may obtain a pressing distance PD of the key 121_1 as 0.

In the embodiment, the controller 110 may preset a distance D1 as a first distance threshold, and preset a distance D2 as a second distance threshold. The second distance threshold is less than the first distance threshold (that is, the distance D2 is less than the distance D1). In the embodiment, the first distance threshold is less than or equal to the full pressing distance (that is, the distance D1 is less than or equal to the distance D0), and the second distance threshold is greater than or equal to 0 (that is, the distance D2 may be greater than or equal to 0).

In the embodiment, the controller 110 may execute the following steps S310 to S350 to determine whether the key 121_1 is lightly touched or normally pressed. In step S310, the controller 110 may obtain the pressing distance PD of the key 121_1. In step S320, the controller 110 determines whether the pressing distance PD is greater than the second distance threshold (that is, whether the distance PD is greater than the distance D2). If the determination result of step S320 is no, the controller 110 may re-execute step S310 to continuously detect the pressing state of the key 121_1. If the determination result in step S320 is yes, in step S330, the controller 110 may determine whether the pressing distance PD is less than the first distance threshold (that is, whether the distance PD is less than the distance D1).

If the controller 110 determines that the pressing distance PD is less than the first distance threshold (that is, the determination result of step S330 is yes), in step S340, the controller 110 may determine that the key 121_1 is lightly touched. As shown in FIG. 4B, FIG. 4B is a schematic diagram of a key being lightly touched according to an embodiment of the disclosure. When the user lightly touches the key cap 401 of the key 121_1, the distance between the bottom of the key cap 401 and the upper surface of the key base 402 may be shortened. In this regard, the controller 110 may determine that the pressing distance PD of the key 121_1 is less than the distance D1 and greater than the distance D2. Therefore, the controller 110 may effectively determine that the key 121_1 is lightly touched.

If the controller 110 determines that the pressing distance PD is greater than or equal to the first distance threshold (that is, the determination result of step S330 is no), in step S350, the controller 110 may determine that the key 121_1 is normally pressed. As shown in FIG. 4C, FIG. 4C is a schematic diagram of a key being normally pressed according to an embodiment of the disclosure. In a condition where the user normally presses the key cap 401 of the key 121_1, the distance between the bottom of the key cap 401 and the upper surface of the key base 402 may be further shortened. In this regard, the controller 110 may determine that the pressing distance PD of the key 121_1 is greater than the distance D1. Therefore, the controller 110 may effectively determine that the key 121_1 is normally pressed. In other embodiments, when the controller 110 determines that the pressing distance PD of the key 121_1 is equal to the distance D1, the controller 110 may determine that the key 121_1 is normally pressed. Moreover, after the foregoing determination process is completed, the controller 110 may re-execute step S310 to continuously detect the pressing state of the key 121_1.

For example, the distance D0 may be, for example, 4 millimeters (mm), that is, the pressing stroke of the key 121_1 may be from 0 mm to 4 mm. The first distance threshold may be, for example, designed as 2 mm, and the second distance threshold may be, for example, designed as 0.05 mm. Therefore, when the user's finger normally presses the key 121_1 to allow the pressing distance PD to be greater than or equal to 2 mm, the controller 110 may determine that the key 121_1 is normally pressed, and the controller 110 may trigger the original key function of the key 121_1. On the contrary, when the user's finger lightly touches the key 121_1 to allow the pressing distance PD to be less than 2 mm and greater than 0.05 mm, the controller 110 may determine that the key 121_1 is lightly touched. In other words, the determination of the first distance threshold may effectively distinguish whether the key 121_1 is normally pressed or lightly touched. In addition, when the user's finger lightly touches the key 121_1 to allow the pressing distance PD to be less than 0.05 mm, the controller 110 may not actuate. In other words, the determination of the second distance threshold may effectively avoid determination by mistake due to an accidental touch of the user.

FIG. 5 is a schematic diagram of a keyboard according to an embodiment of the disclosure. Referring to FIG. 1 and FIG. 5, the keyboard device 100 may, for example, have a keyboard appearance as shown in FIG. 5, but the disclosure is not limited thereto. In the embodiment, the controller 110 may, for example, preset multiple specific keys and a pressing sequence as keys 121_a, 121_b, 121_c, and 121_d, and a, b, c, and d are between 1 and P (including 1 and P). It is noted that, corresponding to a continuous pressing behavior of sliding a finger on and lightly touching keys, locations of the keys 121_a, 121_b, 121_c, and 121_d on the key module 120 are sequentially adjacent, but the disclosure is not limited thereto. In an embodiment, the multiple specific keys may also be multiple keys that are separately configured, and may also be adapted to a keyboard operation behavior of simultaneous or non-simultaneous light touching.

In the embodiment, when the controller 110 determines that the keys 121_a, 121_b, 121_c, and 121_d are continuously and sequentially lightly touched in accordance with a preset pressing sequence within a preset time length, the controller 110 may output a corresponding control command. The control command may be, for example, a shortcut key command that demands an application program executed by the computer device to turn the page to the right, but the disclosure is not limited thereto. For example, during the process of the user operating the keyboard device 100 to input texts, when the user lightly touches multiple keys of the key module 120 and the user's finger slides on the keys first to the left and then to the right, or first to the right and then to the left, the controller 110 outputs a corresponding specific control command to the computer device based on the path or the trajectory formed by multiple keys being lightly touched. Moreover, the text editing program executed by the computer device may, for example, correspondingly move the cursor from the beginning of the line to the end of the line, or move the cursor from the end of the line to the beginning of the line. For another example, during the process of the user browsing the page, when the user lightly touches and slides the user's finger on multiple keys of the key module 120 upward or downward, the page browsing program executed by the computer device may, for example, correspondingly scroll the page up or scroll the page down.

More specifically, in the process of the keys 121_a, 121_b, 121_c, and 121_d being sequentially lightly touched (that is, the user's finger slides on and lightly touches the keys 121_a, 121_b, 121_c, and 121_d), the controller 110 may sequentially record multiple key codes of the keys 121_a, 121_b, 121_c, and 121_d. The controller 110 may determine whether the recording result of the multiple key codes matches multiple specific keys and a pressing sequence that are preset to generate a corresponding control command based on the key codes.

In summary, the keyboard device and the keyboard input method of the disclosure can implement two keyboard input functions of light touching and normal pressing, and can be set for a light touching input to output a corresponding control command. Therefore, the keyboard device and the keyboard input method of the disclosure can implement the functions of shortcut keys, gesture input and even input method input through lightly touching multiple keys.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

1. A keyboard device, comprising:
a key module; and
a controller, electrically connected to the key module, and configured to obtain a plurality of pressing distances of a plurality of keys of the key module,
wherein the controller determines whether a plurality of specific keys in the key module are lightly touched based on the pressing distances,
wherein when the controller determines that the specific keys are lightly touched, the controller outputs a control command,
wherein the pressing distances of the keys that are lightly touched are less than a first distance threshold.
wherein when the controller determines that the specific keys are continuously and sequentially lightly touched in accordance with a preset pressing sequence within a preset time length, the controller outputs the control command.

2. The keyboard device according to claim 1, wherein the pressing distances of the keys that are lightly touched are less than the first distance threshold and greater than a second distance threshold, and the second distance threshold is less than the first distance threshold.

3. The keyboard device according to claim 2, wherein the first distance threshold is less than or equal to a full pressing distance, and the second distance threshold is greater than or equal to 0.

4. (canceled)

5. The keyboard device according to claim 1, wherein when the controller determines that the specific keys are lightly touched, the controller sequentially records a plurality of key codes of the specific keys to generate the corresponding control command based on the key codes.

6. The keyboard device according to claim 1, wherein the keys are a plurality of analog keys, and locations of the specific keys on the key module are sequentially adjacent.

7. The keyboard device according to claim 1, wherein the control command is a shortcut key command.

8. The keyboard device according to claim 1, wherein the control command is a gesture input command.

9. The keyboard device according to claim 1, wherein the control command is an input method command.

10. The keyboard device according to claim 1, wherein when the controller determines that the pressing distance of one of the keys is greater than or equal to the first distance threshold, the controller determines that one of the keys is normally pressed.

11. A keyboard input method, adapted for a keyboard device, wherein the keyboard input method comprises:
obtaining a plurality of pressing distances of a plurality of keys of a key module of the keyboard device;
determining whether a plurality of specific keys in the key module are lightly touched based on the pressing distances; and
outputting a control command when the specific keys are lightly touched,
wherein the pressing distances of the specific keys that are lightly touched are less than a first distance threshold,
wherein when the specific keys are lightly touched, steps of outputting the control command comprise:
outputting the control command when the specific keys are continuously and sequentially lightly touched in accordance with a preset pressing sequence within a preset time length.

12. The keyboard input method according to claim 11, wherein the pressing distances of the specific keys that are lightly touched are less than the first distance threshold and greater than a second distance threshold, and the second distance threshold is less than the first distance threshold.

13. The keyboard input method according to claim 12, wherein the first distance threshold is less than or equal to a full pressing distance, and the second distance threshold is greater than or equal to 0.

14. (canceled)

15. The keyboard input method according to claim 11, wherein when the specific keys are lightly touched, steps of outputting the control command comprise:
sequentially recording a plurality of key codes of the specific keys to generate the corresponding control command based on the key codes when the specific keys are lightly touched.

16. The keyboard input method according to claim 11, wherein the keys are a plurality of analog keys, and locations of the specific keys on the key module are sequentially adjacent.

17. The keyboard input method according to claim 11, wherein the control command is a shortcut key command.

18. The keyboard input method according to claim 11, wherein the control command is a gesture input command.

19. The keyboard input method according to claim 11, wherein the control command is an input method command.

20. The keyboard input method according to claim 11, further comprising:
determining that one of the keys is normally pressed when the pressing distance of one of the keys is greater than or equal to the first distance threshold.
